(19) United States
(12) Patent Application Publication
(10) Pub. No.: US 2016/0196036 A1
(43) Pub. Date: Jul. 7, 2016

(54) METHODOLOGY AND A SYSTEM TO CREATE 3D SPECIFICATIONS FOR THE ASSEMBLY OF PARTS OF A COMPLEX SYSTEM

(71) Applicant: SNECMA, Paris (FR)

(72) Inventors: Alexis Mathon, Mormant (FR); Ziyaad Dargaye, Boulogne-Billancourt (FR); Guillaume Denis Genneteau, Paris (FR); Stephane Jean Rene Laumont, Brottes (FR); Amilcare Pinto, Evry (FR)

(73) Assignee: SNECMA, Paris (FR)

(21) Appl. No.: 14/590,587

(22) Filed: Jan. 6, 2015

(51) Int. Cl. G06F 3/0481; G06T 19/20; G06F 17/50

(52) U.S. Cl. CPC G06F 3/04815; G06F 17/50; G06T 19/20; G06T 2219/004; G06T 2219/2012

(57) ABSTRACT

A method and a system to create 3D specifications for a computer model of a part in an assembly of a complex system that initializes the computer model of the part to include 3D specifications, analyzes whether the part needs to be documented, receives a part reference number in response to determining that the part needs to be documented, analyzes whether the part is included in a 3D model, updates the model in response to determining that the part is not included in the 3D model, and generates a close-up view of the part in response to determining that the part is included in the 3D model, and input 3D specifications of the part in the 3D model.

### BACKGROUND

Complex systems are composed of interconnected parts, when assembled, exhibit one or more properties in addition to the properties of individual parts. For example, an aircraft engine is a complex system with many parts. Specifications for assembling a part of the aircraft engine are created using blueprints, plans and screenshots. The screenshots are manually obtained from a three dimensional (3D) computer model of the aircraft engine. The screenshots are then compiled in a hard or soft copy along with any necessary information needed for the assembly such as parts references and dimensions. Then, the assembler has to search manually for a specific drawing. For example, if the assembler needs a zoomed in view of a part, the assembler has to search between many paper drawings in order to find the correct zoomed in view for the part. FIG. 14 shows an exemplary specification obtained from a screenshot of the computer model of the engine. As shown in FIG. 14, the screenshot is then annotated with the parts reference numbers. FIG. 15 shows another exemplary specification. FIG. 15 shows a magnified view of a group of parts obtained from FIG. 14. The specification shows also a detail view of a part from different perspective. This method may be difficult, tedious, prone to errors, and time consuming. In addition, the screenshot specification techniques adopted makes the work harder for the assemblers and leads to potential errors that can result in significant damage and loss of life. Accordingly, what is needed, as recognized by the present inventors, is a method and a system that facilitate the assembly process by taking into account at least some of the issues discussed above, as well as possibly other issues.

The foregoing “background” description is for generally presenting the context of the disclosure. Work of the inventor, to the extent it is described in this background section, as well as aspects of the description which may not otherwise qualify as prior art at the time of filing, are neither expressly or impliedly admitted as prior art against the present invention. The foregoing paragraph has been provided by way of general introduction, and is not intended to limit the scope of the following claims. The described embodiments, together with further advantages, will be best understood by reference to the following detailed description taken in conjunction with the accompanying drawings.

### SUMMARY

The present disclosure relates to a method to create 3D specifications for a computer model of a part in an assembly of a complex system that initializes the computer model of the part to include the 3D specifications, analyzes whether the part needs to be documented, receives a part reference number in response to determining that the part needs to be documented, analyzes whether the part is included in a 3D model, updates the model in response to determining that the part is not included in the 3D model, generates a close-up view in response to determining that the part is included in the 3D model, and inputs the 3D specifications of the part in the 3D model.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an exemplary illustration of different views used by a system to generate 3D specifications according to one example;

FIG. 2 is an exemplary flowchart to generate a specification according to one example;

FIG. 3 is an exemplary flowchart to initialize the specification according to one example;

FIG. 4 is an exemplary screen layout during the specification initialization according to one example;

FIG. 5 is an exemplary flowchart to generate a close-up view according to one example;

FIG. 6 is an exemplary flowchart to generate a detail view according to one example;

FIG. 7 is an exemplary flowchart to generate a global view according to one example;

FIG. 8 is an exemplary flowchart for using the system on a workstation according to one example;

FIG. 9 is an exemplary flowchart to initialize the workstation according to one example;

FIG. 10 shows an exemplary interface to monitor an assembly progress according to one example;

FIG. 11 shows a group of parts with different types of annotations according to one example;

FIG. 12 shows a hierarchical tree for the dynamic links according to one example;

FIG. 13 is an exemplary block diagram of a computer according to one example;

FIG. 14 is an exemplary specification obtained from a screenshot using a conventional method according to one example; and

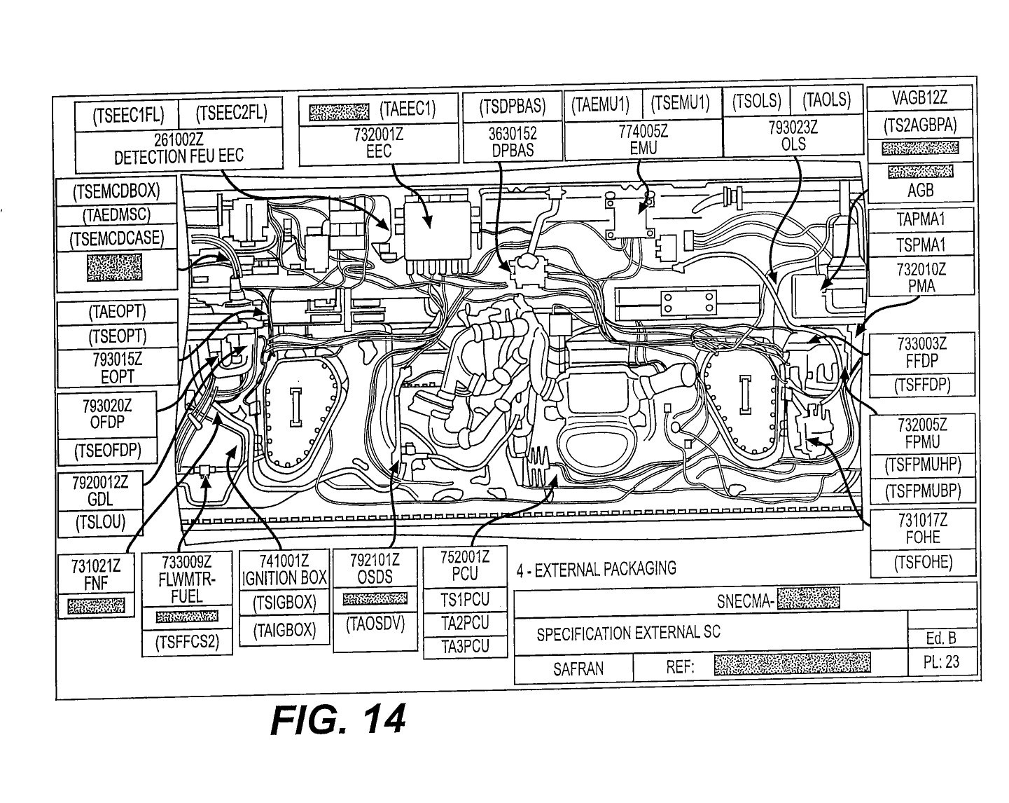

FIG. 15 is a magnified view of a group of parts from an exemplary specification obtained using a conventional method according to one example.

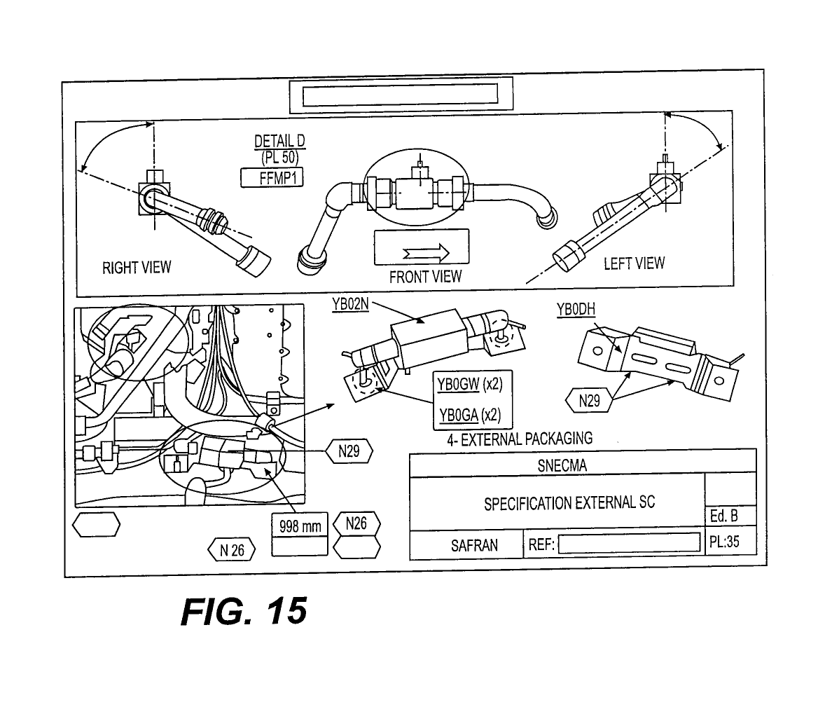

### DETAILED DESCRIPTION

Referring now to the drawings, wherein like reference numerals designate identical or corresponding parts throughout several views, the following description relates to a system and associated methodology for the creation of 3D specifications used in the assembly of a complex system. The 3D specifications may include 3D representation of the part with multiple views, measurements, part number, notes and the like. The 3D specifications may be considered as the 3D equivalent of production drawings. The production drawings are complete sets of drawings detailing the assembly of parts. The main purpose of the production drawings is to define the size, shape, and location of a part. For example, if the design called for a screw to be fastened to a specific torque, the production drawings would typically suggest a tool to be used to fasten the screw. In addition, if the screw is in an inconvenient place the drawings might also elaborate that the fastening is to be done at the beginning of assembly procedure, before access becomes confined.

Specially, as shown in the drawings and related discussion, the 3D specifications are created from a 3D model of the complex system being assembled. The system and associated methodology create the 3D specifications directly from the 3D model generated from numerical modeling. The 3D model may be created using a CAD software. The 3D model may be then converted and imported to a visualization software. The visualization software permits the visualization of product data in 2D and 3D formats. In addition, the system and associated methodology facilitate the visualization by using attributes associated with the 3D model. The attributes may include properties such as color, dimensions, description, annotation, and industrial properties like material, torque and the like.

The complex system assembly may involve hundreds of engineers and technicians such as system engineers, industrial engineers, shop mechanics and other skilled technicians. The absence of a direct link between the specifications and the 3D model makes the work harder for the assemblers. Further, the absence of a direct link between the specifications and other necessary documents for the assembly leads to potential errors that can lead to significant damage and loss of life. The system help assemblers and engineers detect and eliminate inconsistencies and ambiguities in the 3D specifications. The system enables assembly and design errors to be detected and corrected during the 3D specification generation.

In selected embodiment, the complex system may be composed of subsystems each of which is composed of parts. For example, an aircraft is a complex system and is composed of various parts, such as flaps, wing tips, struts, engines and ribs. In one example, the complex system may be an aircraft engine.

The system may use three or more views that represent the 3D model of the complex system at different zoom levels. In one embodiment, the method uses three views: a global view, a close-up view and a detail view. The global view shows the 3D model in large view, may be without any zooming or magnification. The close-up view shows the 3D model at a first level of zooming. The detail view shows the 3D model at a second increased level of zooming. In addition to different zooming levels, each view displays to a user different type of information. Further, each view may present the user with different types of dynamic links to other views or information.

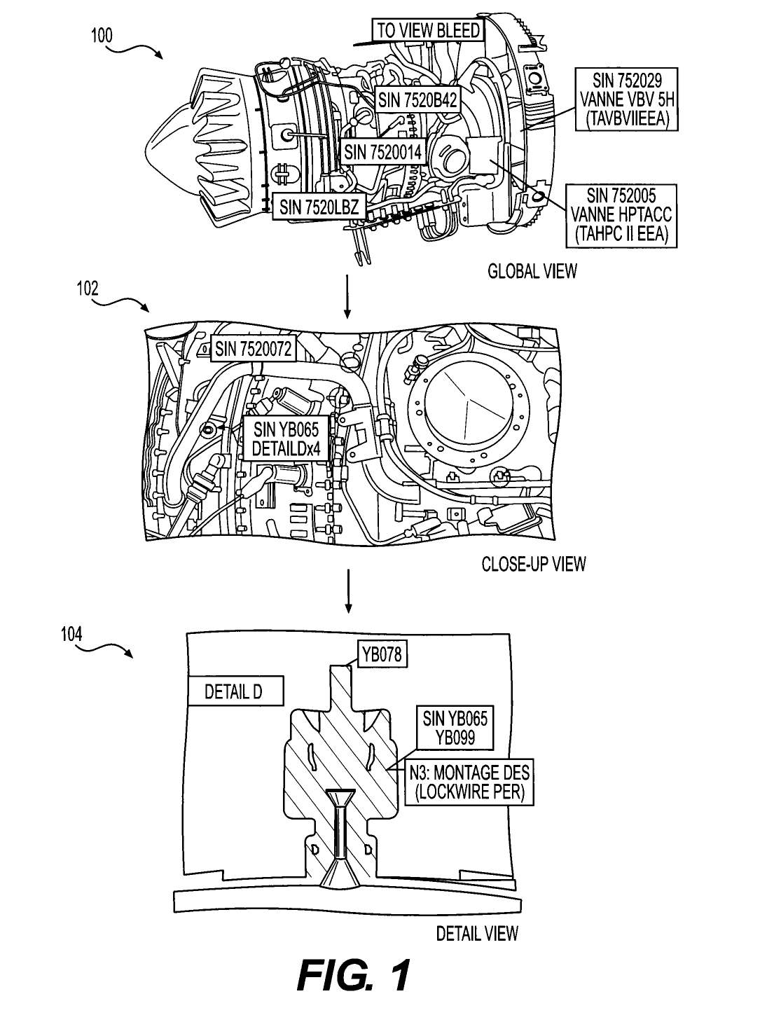

FIG. 1 shows exemplary views according to one example. The global view 100 may depict a group of parts in the 3D model of the complex system. In one embodiment, the global view 100 may depict the group of parts in an engine environment. The main objective of the global view 100 is to give information about spatial positioning of the group of parts. The global view 100 may also give information about the type of assembly. In selected embodiments, the global view 100 may display which parts need to be assembled together. The global view 100 may also display a particular order of assembling the parts. The global view 100 may display additional assembly information. For example, the global view 100 may display the list of cables and measurements that should be connected in the same strand.

The close-up view 102 may depict a magnified view of the group of parts in the engine environment. The close-up view 102 may depict each part's location with respect to its final position. In addition, the close-up view 102 may display information related to its direct environment. The close-up view 102 may display the assembly prerequisites. In one embodiment, the close-up view 102 may display a list of parts that needs to be assembled before assembling the current part. The close-up view 102 may also display a checklist that needs to be performed before assembling a part. In selected embodiments, the user may need to verify that all the tasks in the checklist have been performed. The verification may be done by a designated assembler. The designated assembler may use an interface to indicate that the tasks in the checklist have been performed. The checklist may include verifying that all the prerequisite parts have been assembled correctly. In selected embodiments, the close-up view 102 allows the user to display additional information using the dynamic links. For example, the close-up view 102 may contain a hyperlink to a parts catalog.

The detail view 104 may show extensive details about a particular part. The detail view 104 may depicts the particular part at a higher magnification level than the close-up view 102. The detail view 104 may display specific information needed for the assembly process. The specific information may include information such as a bill of material. Further, the detail view 104 may show information about fasteners. The detail view 104 may display the fasteners reference number, location in warehouse (factory), quantity needed for the assembly and quantity available. In a selected embodiment, the detail view 104 may give information about the tightening torque, welding material, type of glue and the like needed to assemble the part. The detail view 104 may also display information about the lubricant needed to be applied. For example, the detail view 104 may display the type of lubricant and the amount that needs to be applied. The detail view 104 may further display the location of the lubricant in the warehouse and any special instructions related to the lubrication process. For example, the special instructions may include any warnings and information about protective measures that should be taken. In other embodiments, the detail view 104 may permit the visualization of the part with enhancements in order to facilitate the visualization and the comprehension of the specification. The enhancements may include displaying exploded views. The exploded views are blown up views of the part. In other embodiments, the detail view 104 may also contain links to animations that show, for example, how the part is being assembled. The detail view 104 may also contain links to cross section views and images of the part. The cross section views are obtained by cutting the 3D model at different predetermined cutting planes. The images may be real photos of the part obtained using a camera. Presenting the assembler with images of the part facilitates identifying the part from other parts, which may decrease the risk of error. The images may be stored in a memory. The images may show the part from a plurality of angles. In selected embodiments, the detail view 104 may only be accessible through a dynamic link from the close-up view 102 and/or the global view 100.

In the following paragraphs, the creation of a specification using processing circuitry is detailed. The user may use a tablet, a computer, a server or the like to create the 3D specifications from the 3D model. In selected embodiments, the computer may send via a network the information to the server. The server may represent one or more servers.

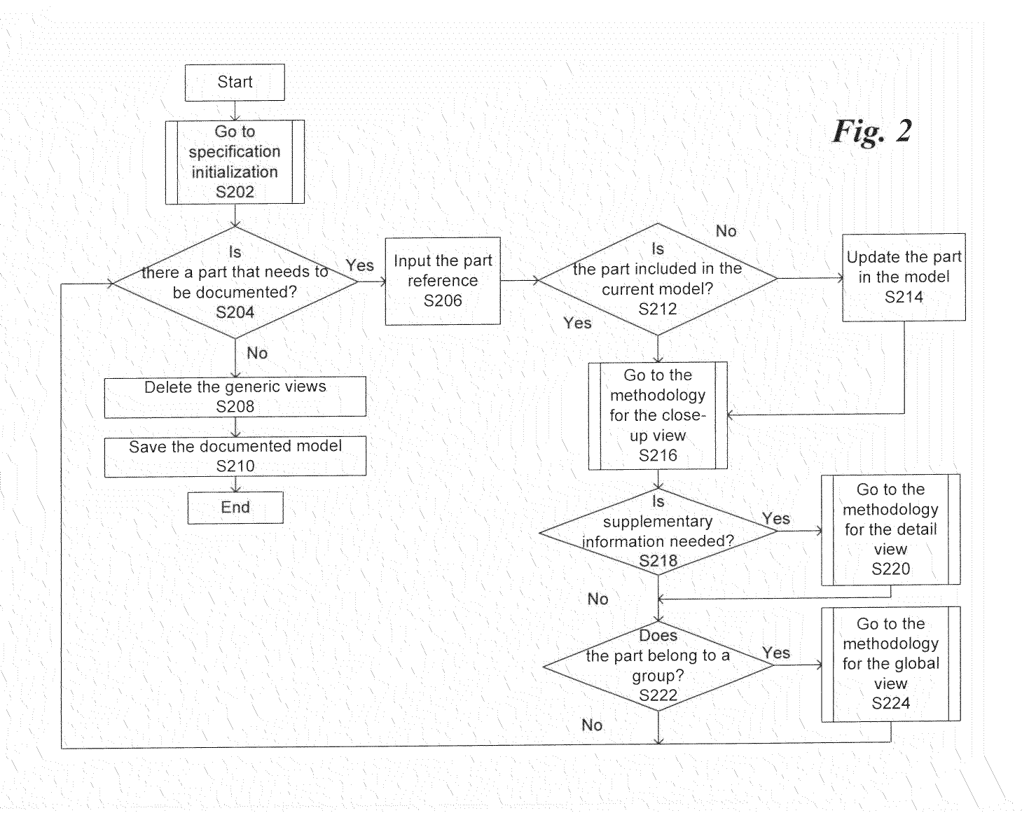

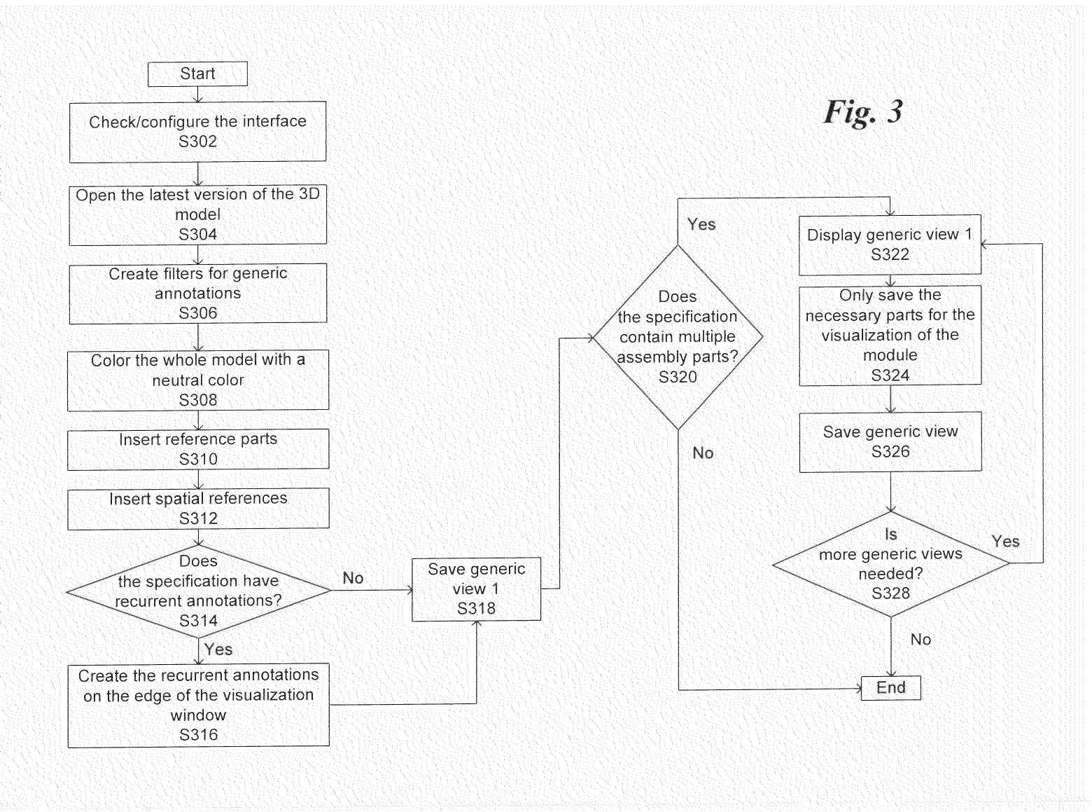

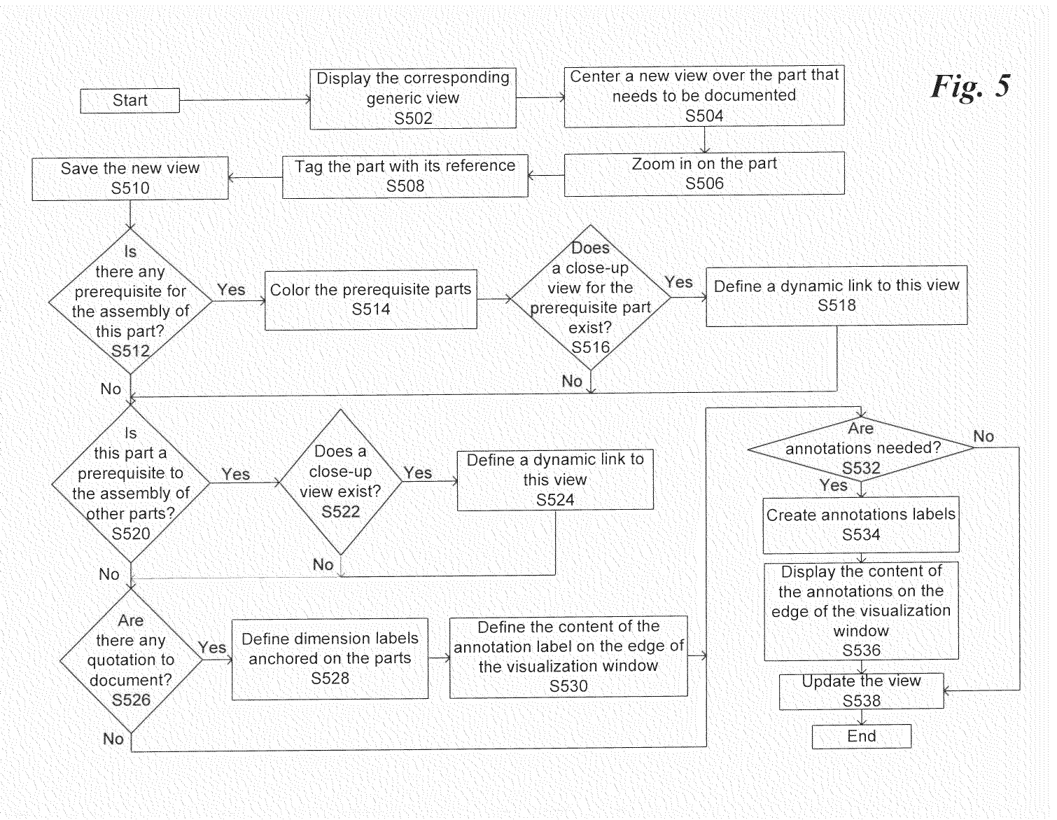

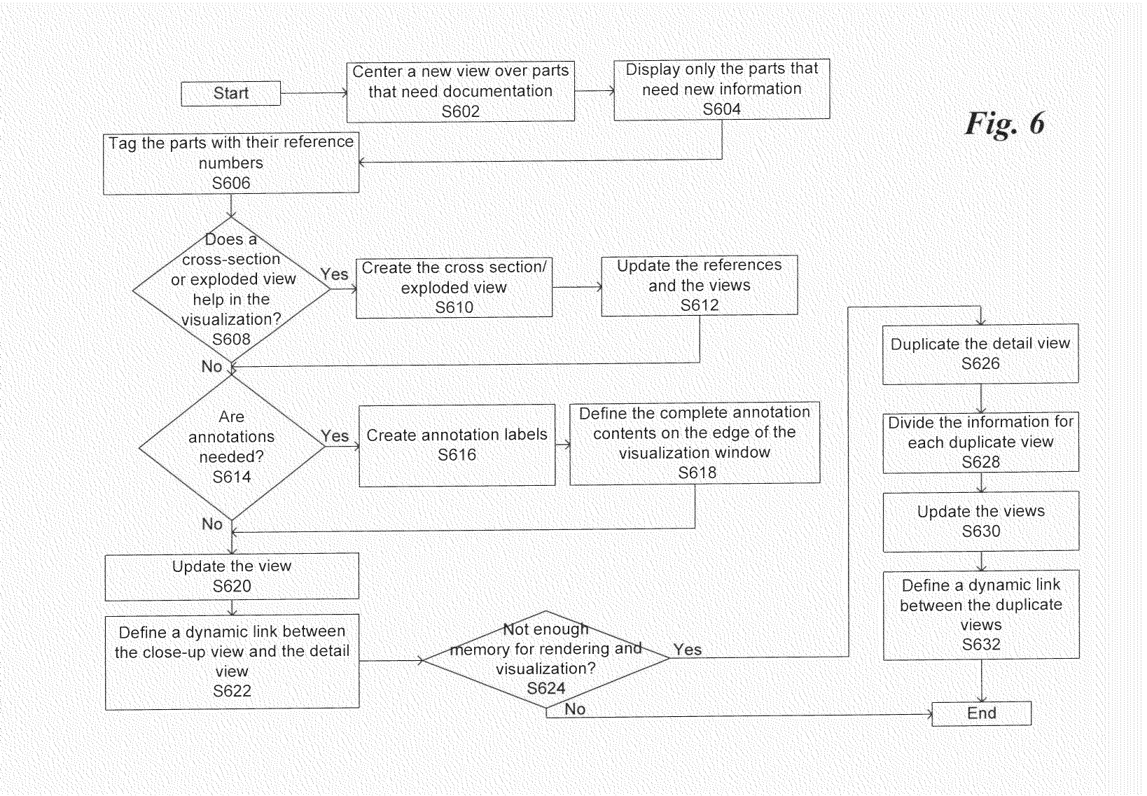

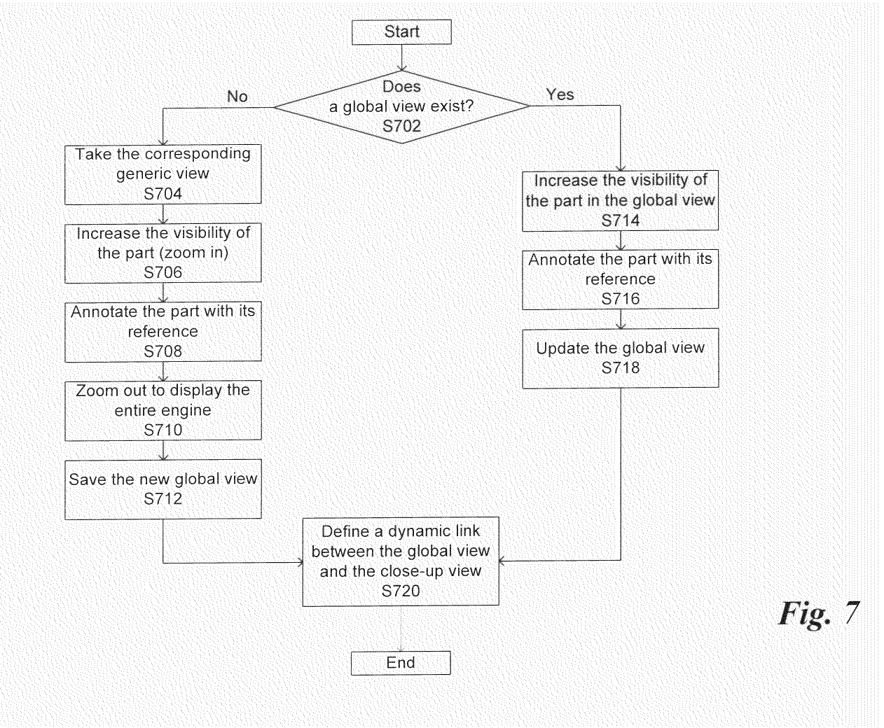

FIG. 2 is an exemplary flowchart illustrating the creation of a specification by the system. At step S202, the process starts by a specification initialization process as explained later and shown in FIG. 3. At step S204, the user checks whether there is a part that needs to be documented through an interactive input/output operation between the user and the system. At step S206, in response to the user indicating that the part needs to be documented, the user enters the reference number in the visualization software, and the visualization software, using the processing circuitry, finds the part in the 3D model and displays it. The user may input the reference number of the part using a plurality of methods. The user may use a keyboard, a microphone, a mouse or any other device as would be understood to one of ordinary skill in the art. At step S212, the processing circuitry checks whether the part is included in the current model. The processing circuitry may compare the reference number of the part entered by the user with a list of reference numbers stored in the memory. The list may contain all the reference numbers of the parts included in the current model. In response to determining that the part is not included in the current model, the step goes to S214. At step S214, the part is inserted in the current model. At step S216, in response to the part being included in the current model, the flow goes to the close-up view process as explained later and shown in FIG. 5. At step S218, the system checks whether supplemental information needs to be displayed. In response to determining that supplementary information is needed, the detail view process is executed at step S220. The creation of the detail view is explained later and shown in FIG. 6. Then, at step S222, the user may indicate whether the part belongs to a group of parts. In response to determining that the part belongs to a group of parts then the flow goes to S224. At S224, the global view process is executed to create the global view. The global view process is explained later and shown in FIG. 7. The steps S204, S206, and S212-S224 are repeated until there is no more parts that need to be documented then the process goes to step S208. In response to determining that no more parts need to be documented, the system deletes the generic views created during the initialization process, at step S208. At step S210, the model is saved.

FIG. 3 is an exemplary flowchart to initialize the specification. FIG. 3 shows the steps executed at step S202. At step S302, the user configures the interface according to the display requirements. In selected embodiments, the display may be a tablet. At step 304, the processing circuitry opens the latest saved 3D model. In one embodiment, the 3D model can be saved in the memory of the tablet. In other embodiments, the 3D model may be saved in the memory of a computer. At step S306, the user creates display filters for generic annotations display. The display filters are created to classify further displayed annotations in category in order to facilitate the final user utilization. At step S308, the processing circuitry changes the attributes of the model. In selected embodiments, changing the attributes of the model may include coloring the model with a neutral color. In one embodiment, the model can be colored in a light grey. At step S310, the user may insert reference parts to the specification. The user may use an interface to input the reference parts. At step S312, the user may insert spatial references. The spatial references parts may include mid-section horizontal and vertical planes in the global view, and also contain zoning parts in order to delimitate hot/cold zones information, forbidden glue utilizations zones, and the like. At step S314, the user checks whether the specification has recurrent annotations. At step S316 in response to determining that the specification contains the recurrent annotations, the user creates recurrent annotation visible on the edge of the window. If the specification does not have any recurrent annotations then the flow goes to step S318. At step 318, the generic view is saved and the flow goes to step S320. At step S320, the user checks whether the specification has multiple assembly parts. If the specification does not contain multiple assembly parts then the process ends. At step S322, in response to the user indicating that the specification has multiple assembly parts, the processing circuitry displays generic view 1. At step S324, only the necessary parts needed in the visualization assembly of the current module are saved in the new view. In other embodiments, the user may indicate which parts are necessary using the user interface. At step S326, the updated generic view is saved. The steps S322 to S328 are repeated for all the generic views needed.

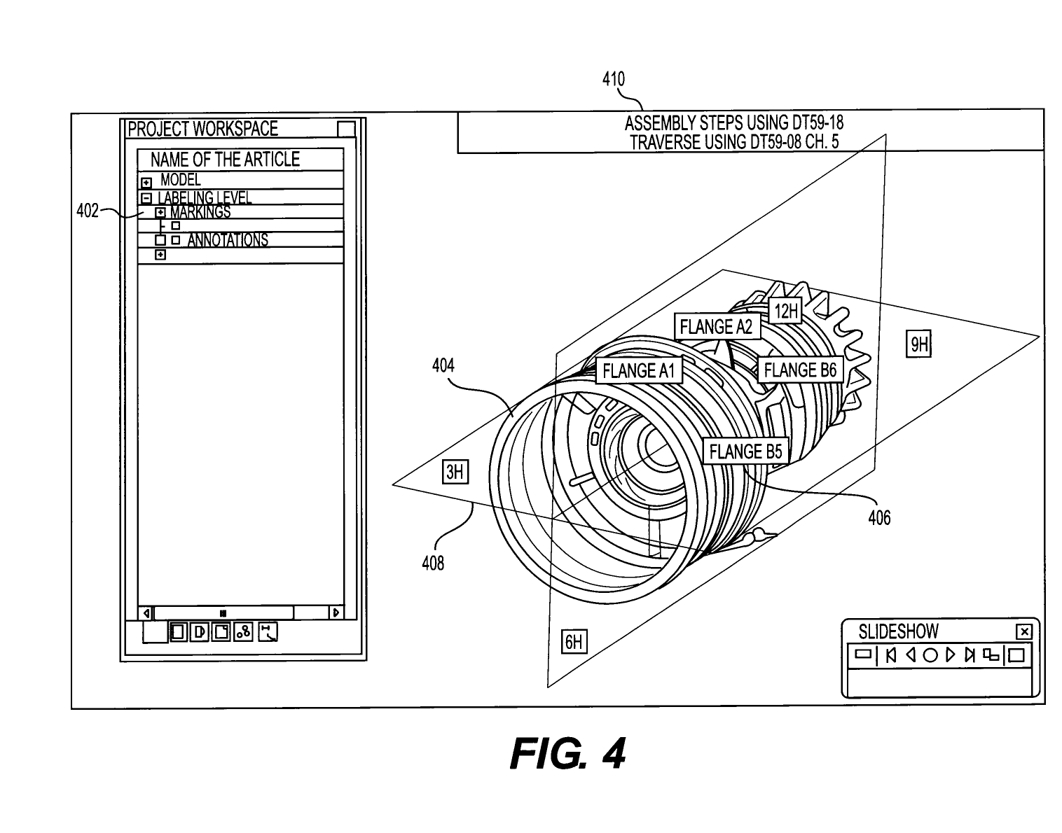

FIG. 4 shows an exemplary screen layout during the specification initialization process according to one example. Exemplary generic filters 402 created at step S206 are shown. The model is colored with a neutral color 404 at step S308. 406 shows the reference parts inserted at step S310. 408 are exemplary spatial references inserted at S312. 410 are exemplary annotations shown at the edge of the visualization window created at step S316.

FIG. 5 is an exemplary flowchart to create a close-up view according to one example. The flowchart shows the steps executed by the user at step S216. As shown in FIG. 1, the close-up view may depict a magnified view of the group of parts in the complex system, for example the aircraft engine or even smaller groups of parts. At step S502, the generic view is displayed. At step S504, a new view is created over the part (selected at step S206) that needs to be documented. At step S506, a zoom in or blow up on the part is performed. At step S508, the part is annotated with its reference. The part may be annotated by many techniques including placing a balloon, a callout or the like. At step S510, the new view is saved in the memory. At S512, the user may indicate whether there is any prerequisite for the assembly of this part. A prerequisite part may be a part that needs to be assembled before the current part. For example, the current part may need to be attached to the prerequisite part. In another example, the current part may limit the accessibility to certain location in the complex system. Thus certain parts may need to be assembled before the access becomes confined. In response to determining that the assembly of this part has prerequisites, the user, using the processing circuitry, changes the attributes of the prerequisite parts at step S514. In one example, changing the attributes of the prerequisite parts may include changing the color of the prerequisite parts. Then at step S516, the user may check whether the close-up view exits for the prerequisite part. At step S518, in response to determining that the close-up view exists, the processing circuitry creates a dynamic link to the close-up view of the prerequisite part then the flow goes to step S520. In selected embodiments, this process is repeated for all the prerequisite parts. At step S520, the user may indicate using the interface whether the part is a prerequisite to the assembly of other parts. In response to determining that the part is a prerequisite to the assembly of other parts, the user may indicate whether the close-up view already exists at step S522. Then, in response to determining that the close-up view exists, the processing circuitry creates a dynamic link to this view at step S524. If the close-up view does not exist then the process goes to step S526. At step S526, the user may indicate whether measurements and quotations need to be documented. In selected embodiments, the measurements may include linear and/or angular dimensions. In response to determining that measurements exists, the processing circuitry, at step S528, defines dimension label tagged on the parts. In selected embodiments, the dimensions provide the actual size of the part. Then at step S530, the complementary content of the annotation labels are displayed on the edge of the visualization window. At step S532, the user may indicate whether annotations are needed. In response to determining that annotations are needed, the processing circuitry creates annotation labels at S534. Then, at step S536, the complete content of the annotation labels are defined on the edge of the visualization window. Then, at step S538 the view is updated. If no annotations are needed then the process goes to S538.

In selected embodiments, the global view may permit zooming in and out. The dynamic zooming is realized through the creation of the dynamic links between the global view and close-up views.

FIG. 6 is an exemplary flowchart to create the detail view according to one example. The detail view process is executed at step S220 as explained in FIG. 2. The detail view may show extensive detail about the particular part. At step S602, the user centers a new view over the parts that need to be documented. At step S604, only parts that need new information are displayed. At step S606, the parts are labeled with their reference numbers. At step S608, the user may indicate whether cross sections view or an exploded view may help in the visualization. The user may indicate through the interface that the part is complex and the creation of cross sections is needed. In response to determining that the cross section view and/or the exploded view may help in the visualization, the cross section and/or the exploded view are created by the user at step S610. At step S612, the references and the views are updated. At step S614, the user may indicate whether annotations are needed. At step S616, in response to determining that annotations are needed, the processing circuitry creates the annotation labels. Then, at step S618, the complete annotation contents are displayed on the edge of the visualization window. At step S620, the view is updated. At step S622, a dynamic link between the close-up view 102 and the detail view 104 is created. At step S624, the user checks whether there is enough memory for rendering and visualization composing with hardware limitations. The user may determine whether there is enough memory by comparing the available memory with a predetermined value. In response to determining that there is not enough memory due to both processing circuitry and visualization software limitations, at step S626, the detail view is duplicated. Next, the information is divided in between the two duplicate views at step S628. At S630, the views are updated. At S632, a dynamic link between the two duplicate views is defined.

FIG. 7 is an exemplary flowchart to create the global view according to one example. The flowchart shows the details steps executed by the processing circuitry at step S224. As shown in FIG. 1, the global view depicts the position of a group of parts with respect to the complex system, for example the aircraft engine. At step S702, the user may indicate whether the global view already exists. At step S714, in response to determining that the global view already exists, the processing circuitry increases the visibility of the part in the global view. In selected embodiments, increasing the visibility of the part may include changing the color of the part. For example, the part can be displayed with a noticeable color such as yellow while the entire model is displayed with a light grey color. At step S716, the part is labeled with a reference number. The reference number may be automatically obtained from a part database. The part database may be saved in the memory. At step S718, the global view is updated. Then the flow goes to step S720. At step S720, a dynamic link between the global view and the close-up view is defined. In response to determining that the global view does not exist, then at step S704, the processing circuitry may take the corresponding generic view. Then, at step S706, the visibility of the part is increased. At step S708, the part may be tagged with the reference number. At step S710, the processing circuitry displays the entire engine by zooming out. At step S712, the new global view is saved and the step goes to S720. In selected embodiments, the global view may be saved in the memory.

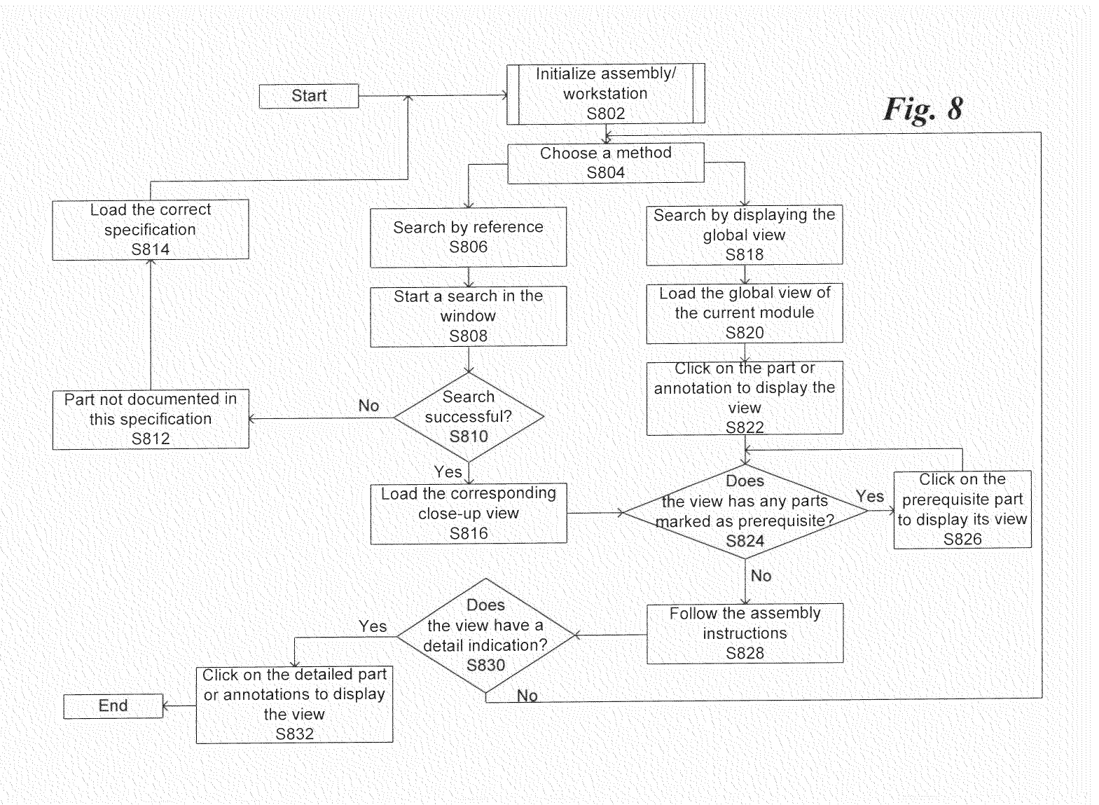

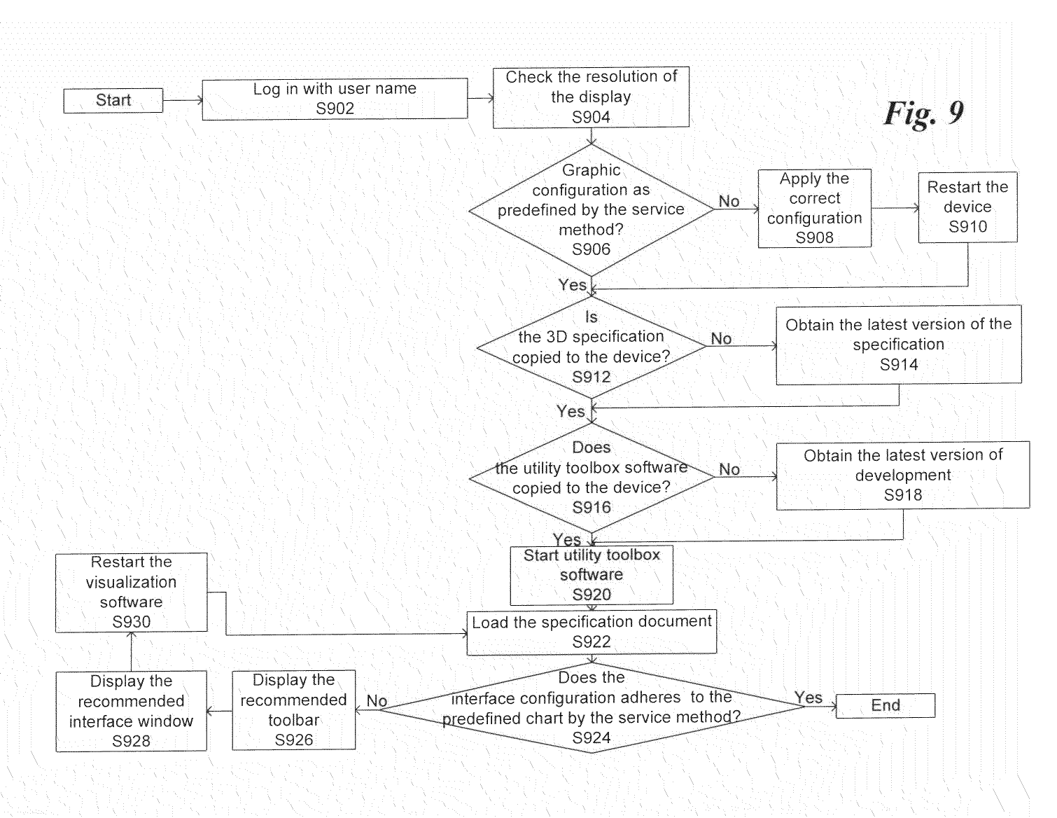

FIG. 8 is an exemplary flowchart for using the model with 3D specifications on a workstation according to one example. At step S802, the process of initializing the workstation, as explained in FIG. 9, is executed. The workstation may be a computer, a tablet, or the like. The workstation may represent a plurality of workstation located in a factory. At step S804, the user may choose a method to search for the part. A first method is to search by reference number. A second method is to search by displaying the global view. The user may input the method of choice using the interface. If the user chooses search by reference then the process goes to S806. At step S808, a search is initiated in the window. At step S810, the processing circuitry checks whether the search is successful. In response to determining that the search is successful, the processing circuitry loads the corresponding close-up view at step S816. In response to determining that the search was not successful, then the process goes to step S812. At step S812, the user is informed that the part is not documented in this specification. In selected embodiments, a warning may be displayed on the display screen. Then at step S814, the correct specification is loaded and the process goes to S802. At step S824, the user checks whether the view has any parts marked as prerequisite. In response to determining that the view has prerequisite parts, the user may click on the prerequisite part to display its view at step S826. Step S826 is repeated for all the parts marked as prerequisite. At step S828, the user may follow the assembly instruction displayed on the screen. At step S830, the user checks whether the view requires a more detailed indication that necessitates a dedicated detailed view. In response to determining that the view has a detail indication, the user may click on the detail annotation to display the view at step S832. If no detail indication is present, the process goes to S804. At S804, the user may choose to search by displaying the global view (step S818). At step S820, the global view of the current model is loaded. Then, at step S822, the user may click on the part or the annotation to display the view.

FIG. 9 is an exemplary flowchart to initialize the visualization specification according to one example. In selected embodiments, the following process may be executed at step S802. At step S902, the user login to the system using a username. Then, at step S904, the processing circuitry obtains the resolution of the display screen. At S906, the processing circuitry checks whether the graphic configuration is as recommended in accordance with the processing circuitry properties. In response to determining that the graphic configuration is not as recommended, the processing circuitry may apply the correct configuration at step S908. At S910, the workstation is restarted. At step S912, the processing circuitry checks whether the 3D specification is copied to the workstation. In response to determining that the 3D specification is not copied to the workstation, the processing circuitry may download the latest version of the specification from the network at step S914. At step S916, the processing circuitry may check whether the search method toolbox utility software is copied to the workstation. In response to determining that the search method toolbox utility software is not copied to the workstation then at S918, the processing circuitry, via communication circuitry downloads the latest version of development from the network. At S920, the method toolbox utility software-is executed. At step S922, the specification documents are loaded. At step S924, the user checks whether the interface configuration is as recommended in accordance with the processing circuitry properties. In response to determining that the configuration is not as recommended in accordance with the processing circuitry properties, the user may choose to display the recommended toolbar at step S926. At step S928, the processing circuitry displays the recommended interface window. Then, at step S930, the visualization process is restarted.

In selected embodiments, users may access additional graphical user interfaces (GUI) linked to a database. For example, the database may be reference parts. The assemblers may also update the progress of the engine assembly. In selected embodiments, the system may include additional user interface that performs a search by reference number and display information about the part. In other embodiments, the user may verify the part version and the reference number with a designated database including the reference parts.

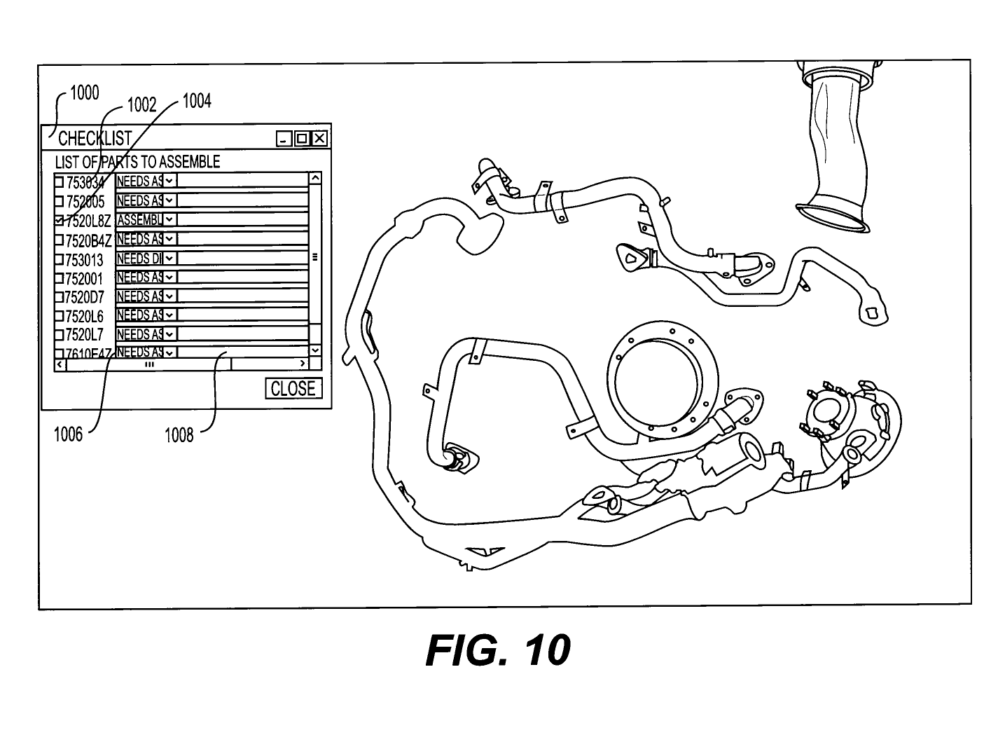

FIG. 10 shows an exemplary interface to monitor the assembly progress. 1000 shows an exemplary interface for a checklist. The checklist lists all the parts that need to be assembled. The list may contain several fields. 1002 contains the part reference number. 1006 shows the assembly status of the part. For example, 1006 may show that the part is “assembled”, “needs assembling”, “currently being assembled” or “needs disassembling”. 1008 represents an empty field where the assembler may input notes. 1004 is a check box to display the part. In one embodiment, the assembler may display all the parts already assembled. The processing circuitry may use text matching techniques to compare the text in the field 1006 with “assembled” to determine that the part has been assembled and thus display the part. The processing circuitry may further change the attributes of the part depending on the assembly status of the part. For example, the parts with an assembly status of “needs disassembling” may be shown with a red color.

In other embodiments, the user may display a list of all parts that are currently being assembled. Further, the list may show the name of the assembler. The list may include different types of information regarding parts of the complex system. For each of one or more parts, for example, the list may include a name, number (e.g., part number) or other identifier of the part, a required quantity of the part, the source of the part, related part identifier or the like. The list may also give an estimated time to finish assembling the part by the worker.

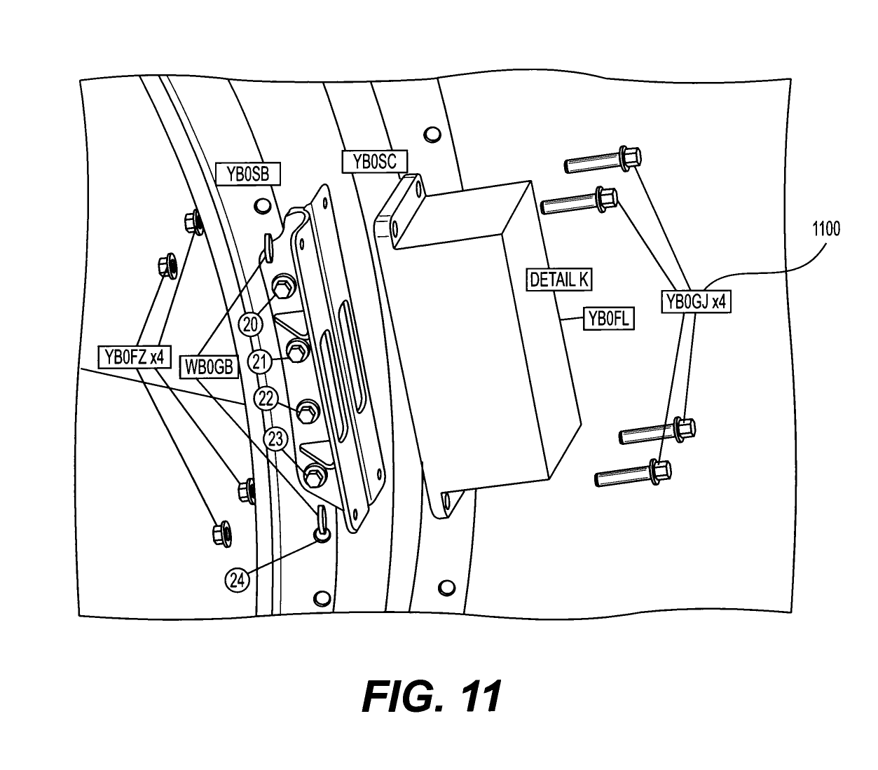

FIG. 11 shows a group of parts with different types of annotations. FIG. 11 shows different type of annotations. An annotation may be a note, a symbol, a label or the like which is composed of characters. The annotation may include placing a balloon or a callout. In selected embodiments, the annotations may be chosen from metadata of the model. The metadata may be stored in the memory. The metadata maybe updated during the design process. The annotation label may also include the number of parts as shown in 1100. The annotations maybe created at steps S534, S528, S606, S616, S716 and S708. The annotations properties may be changed. For example, the annotation maybe displayed with “coarse”, “medium” or “fine” font style.

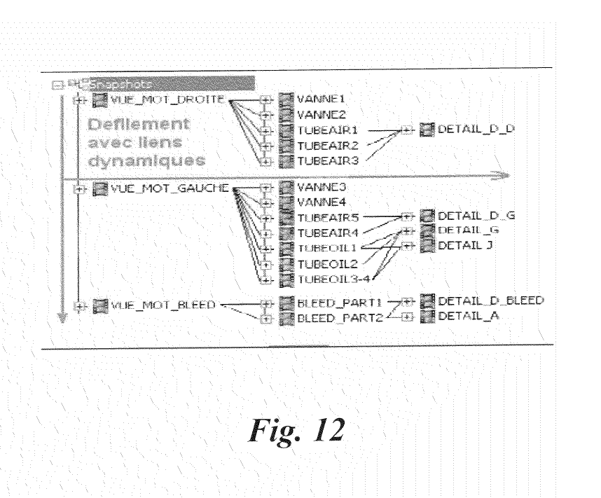

FIG. 12 shows a hierarchical tree for the dynamic links. The dynamic links can be created in steps S518, S524, S632, S622 or S720. In selected embodiments, access to a certain dynamic links may be restricted to some users. For example, access to deleting a required part may be restricted to designated users such as engineers. The dynamic links permits to the assemblers to navigate easily between different views.

In selected embodiments, the system may include a navigation engine. The navigation engine may be configured to select one or more navigation options from a plurality of navigation options for navigating the layout (view) in which the navigation options may be selected according to the associated metadata for the view.

The navigation options may be maintained in a respective storage such as the memory. The navigation engine may also be configured to communicate the selected navigation options, such as to a GUI in which the selected navigation options may be presented along with the layout. In one embodiment, the navigation engine may be configured to select navigation options according to the type of the specification being displayed, which may be indicated in the associated metadata. Examples of suitable navigation options for a layout include command tools (e.g, pan, rotate, zoom) annotation tools (timeline/milestone, callout), linking tools (hyperlink, hotlink, hotspot) navigation path tools (tracking recording) metadata tools such as search, filter, insertion, page tools search filter, cue activation, size, location, dominance, logical relationship, layout model change, co-navigation, hyper hypo navigation, printing or the like.

The proposed system may be integrated into existing software. In selected embodiments, the system may be integrated with TeamCenter Visualization.

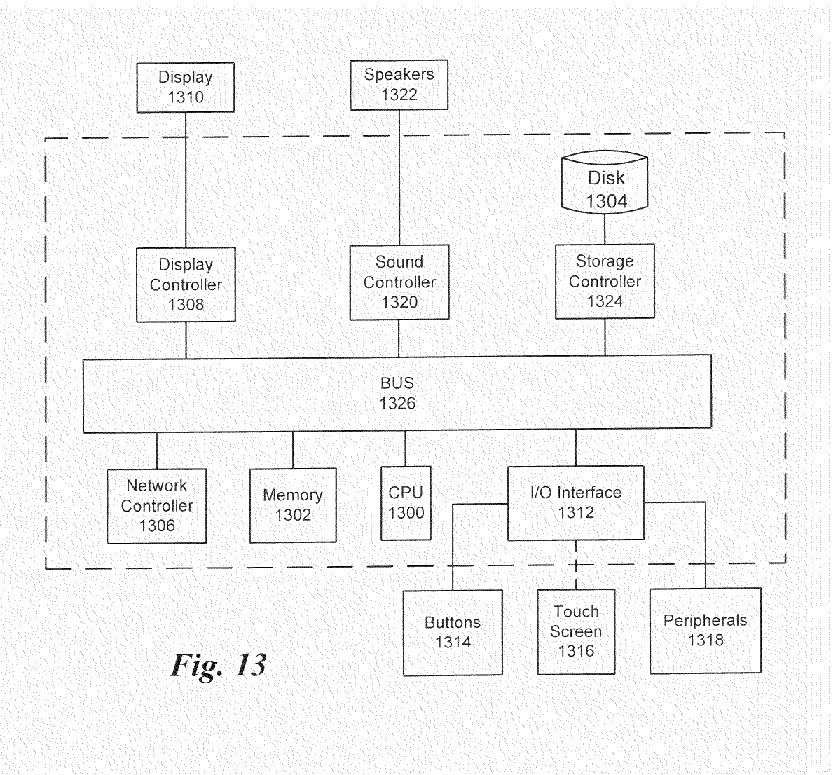

FIG. 13 is an exemplary block diagram of the computer 100 according to one example. In FIG. 13, the computer includes a CPU 1300 which performs the processes described above. The process data and instructions may be stored in memory 1302. These processes and instructions may also be stored on a storage medium disk 1304 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the mobile device communicates, such as a server or computer.

Further, the claimed advancements may be provided as a utility application, background daemon, or component of an operating system, or combination thereof, executing in conjunction with CPU 1300 and an operating system such as Microsoft Windows 7, UNIX, Solaris, LINUX, Apple MAC-OS and other systems known to those skilled in the art.

CPU 1300 may be a XENON® or CORE® processor from Intel of America or an OPTERON® processor from AMD of America, or may be other processor types that would be recognized by one of ordinary skill in the art. Alternatively, the CPU 1300 may be implemented on an FPGA, ASIC, PLD or using discrete logic circuits, as one of ordinary skill in the art would recognize. Further, CPU 1300 may be implemented as multiple processors cooperatively working in parallel to perform the instructions of the inventive processes described above.

The computer in FIG. 13 also includes a network controller 1306, such as an Intel Ethernet PRO network interface card from Intel Corporation of America, for interfacing with a network. As can be appreciated, the network can be a public network, such as the Internet, or a private network such as an LAN or WAN network, or any combination thereof and can also include PSTN or ISDN sub-networks. The network can also be wireless such as a cellular network including EDGE, 3G and 4G wireless cellular systems. The wireless network can also be WiFi, Bluetooth, or any other wireless form of communication that is known.

The computer further includes a display controller 1308, such as a NVIDIA® GeForce GTX or QUADRO® graphics adaptor from NVIDIA Corporation of America for interfacing with display 1310, such as a Hewlett Packard HPL2445w LCD monitor. A general purpose I/O interface 1312 interfaces with a keyboard and/or mouse 1314 as well as a touch screen panel 1316 on or separate from display 1310. General purpose I/O interface also connects to a variety of peripherals 1318 including printers and scanners, such as an OfficeJet or DeskJet from Hewlett Packard.

A sound controller 1320 is also provided in the computer, such as Sound Blaster X-Fi® Titanium from Creative, to interface with speakers/microphone 1322 thereby providing sounds and/or music.

The general purpose storage controller 1324 connects the storage medium disk 1304 with communication bus 1326, which may be an ISA, EISA, VESA, PCI, or similar, for interconnecting all of the components of the computer. A description of the general features and functionality of the display 1310, keyboard and/or mouse 1314, as well as the display controller 1308, storage controller 1324, network controller 1306, sound controller 1320, and general purpose I/O interface 1312 is omitted herein for brevity as these features are known.

A method that includes the features in the foregoing description provides numerous advantages to the users. In particular, the method facilitates the assembly of the parts of an engine by creating a link between the 2D specification and the 3D model. The assemblers have access to all necessary documentation and information through dynamic links. In addition, the method displays to the assembler any warnings and detailed steps thus minimizing assembly errors. The method also permits viewing the assembly progress thus leading to a better team management thus optimizing resources. The system and associated methodology provides a collaborative assembly that can track the assembly progress precisely while being economically cost effective.

Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

1. A method for creating 3D specifications for a computer model of a part in an assembly of a complex system, the method comprising:
initializing, via processing circuitry, the computer model of the part to include 3D specifications;
analyzing, via the processing circuitry, whether the part needs to be documented;
receiving, via a user interface, a part reference number in response to determining that the part needs to be documented;
analyzing, via the processing circuitry, whether the part is included in a 3D model;
updating the 3D model to include the part in response to determining that the part is not included in the 3D model;
generating a close-up view of the part in response to determining that the part is included in the 3D model; and
inputting 3D specifications of the part in the 3D model.

2. The method of claim 1, further comprising:
generating a detail view;
generating a global view; and
generating the close-up view.

3. The method of claim 1, further comprising:
analyzing, using the processing circuitry, whether supplementary information is needed; and
displaying, the detail view upon determining that supplementary information is needed.

4. The method of claim 1, further comprising:
checking, using the processing circuitry, whether the part belongs to a group; and
displaying, the global view in response to determining that the part belongs to the group.

5. The method of claim 2, wherein generating the close-up view comprises:
displaying a generic view;
zooming in on the part;
annotating the part with the part reference number;
analyzing whether there are a prerequisite to assembling the part;
changing the properties of prerequisite parts in response to determining that there are prerequisite to the assembly of the part;
analyzing whether the part is the prerequisite to the assembly of other parts;
checking whether a close-up view exists, in response to determining that the part is the prerequisite to the assembly of the other parts; and
defining, a dynamic link to the close-up view in response to determining that the close-up view exists.

6. The method of claim 5, wherein changing the properties of the prerequisite parts includes changing the color of the prerequisite parts.

7. The method of claim 2, wherein generating the detail view comprises:
displaying parts that needs documentation;
annotating the parts with the parts reference number;
determining, via the processing circuitry, whether a cross section view helps in the visualization;
displaying the cross section view in response to determining that the cross section view helps in the visualization; and
defining, the dynamic link between the close-up view and the detail view.

8. The method of claim 7, wherein defining includes relating an annotation shown on a 3D specification with the detail view.

9. The method of claim 7, wherein the annotation includes assembly information from the 3D model metadata.

10. The method of claim 1, wherein the method is associated with a visualization software.

11. The method of claim 1, wherein the complex system is an aircraft engine.

12. The method of claim 1, further comprising:
monitoring the assembly progress.

13. The method of claim 12, wherein monitoring the assembly progress comprises:
indicating an assembly status of the part; and
changing the properties of the part based on the assembly status.

14. A system for creating 3D specifications for a computer model of a part in an assembly of a complex system, the system comprising:
processing circuitry configured to:
initialize the computer model of the part to include 3D specifications,
analyze whether a part needs to be documented,
receive, via a user interface, a part reference number in response to determining that the part needs to be documented,
analyze whether the part is included in a 3D model,
update the 3D model to include the part in response to determining that the part is not included in the 3D model,
generate a close-up view of the part in response to determining that the part is included in the 3D model, and
input 3D specifications of the part in the 3D model.

15. The system of claim 14, wherein the processing circuitry is further configured to:
generate a detail view;
generate a global view; and
generate the close-up view.

16. The system of claim 14, wherein the processing circuitry is further configured to:
analyze whether supplementary information is needed; and
display the detail view upon determining that supplementary information is needed.

17. The system of claim 14, wherein the processing circuitry is further configured to:
check, using the processing circuitry, whether the part belongs to a group; and
display, the global view in response to determining that the part belongs to the group.

18. The system of claim 15, wherein generating the close-up view comprises:
displaying a generic view;
zooming in on the part;
annotating the part with the part reference number;
analyzing whether there are a prerequisite to assembling the part;
changing the properties of prerequisite parts in response to determining that there are prerequisite to the assembly of the part;
analyzing whether the part is the prerequisite to the assembly of other parts;
checking whether a close-up view exists, in response to determining that the part is the prerequisite to the assembly of the other parts; and
defining, a dynamic link to the close-up view in response to determining that the close-up view exists.

19. A non-transitory computer readable medium having computer-readable instructions stored therein for creating 3D specifications for a computer model of a part in an assembly of a complex system, that when executed by a computer causes the computer to perform a method comprising:
initializing, via processing circuitry, the computer model of the part to include 3D specifications;
analyzing, via the processing circuitry, whether the part needs to be documented;
receiving, via a user interface, a part reference number in response to determining that the part needs to be documented;
analyzing, via the processing circuitry, whether the part is included in a 3D model;
updating the 3D model to include the part in response to determining that the part is not included in the 3D model;
generating a close-up view of the part in response to determining that the part is included in the 3D model; and
inputting 3D specifications of the part in the 3D model.
